(19) United States
(12) Patent Application Publication
(10) Pub. No.: US 2003/0213895 A1
(43) Pub. Date: Nov. 20, 2003

(54) Optical power and performance monitoring of a PLC chip using sensors mounted on the chip

(75) Inventor: Reuven Duer, Moshav Talmei Elazar (IL)

Correspondence Address: DR. MARK FRIEDMAN LTD., C/o Bill Polkinghorn, Discovery Dispatch, 9003 Florin Way, Upper Marlboro, MD, 20772, US

(73) Assignee: LYNX PHOTONIC NETWORKS INC.

(21) Appl. No.: 10/206,115

(22) Filed: Jul. 29, 2002

Related U.S. Application Data
(60) Provisional application No. 60/380,255, filed on May 15, 2002.

(51) Int. Cl. G01B 9/10

(52) U.S. Cl. 250/227.31

(57) ABSTRACT

The optical power in a waveguide of an optical circuit is monitored by mounting an optical sensor, such as a photodiode, laterally apart from the waveguide but sufficiently close to the waveguide to detect light emerging laterally from the waveguide, and by receiving signals from the sensor that are representative of the optical power. In a DWDM circuit, a bandpass filter is placed between the waveguide and the sensor for monitoring only one of the wavelengths carried by the waveguide. To minimize crosstalk, the monitored portions of the waveguides are isolated from each other, for example by trenches or by optically absorptive barriers. Suitably calibrated processing of signals from several sensors that monitor several waveguides eliminates crosstalk.

This is a continuation in part of U.S. provisional patent application Ser. No. 60/380,255 filed May 15, 2002.

### FIELD AND BACKGROUND OF THE INVENTION

The present invention relates to integrated optical circuits and, more particularly, to a method of monitoring optical power in a planar lightwave circuit Is (PLC) chip and to the circuit so monitored.

Optical power and signal monitoring is an essential part of any system employing routing of optical signals. Currently the largest foreseen application is in dense wavelength division multiplexing (DWDM) optical networks as used in data communication and in telecommunication. In order to operate the network and maintain its quality of service, the network management needs to continuously monitor both power levels and signal integrity in many places along the network. Since any such DWDM optical network is built to carry many wavelengths (typically more than 40 wavelengths), monitoring of all these channels in a reliable and cost-effective way becomes a very important and complicated task.

Other applications for optical communication and PLC devices are anticipated in the near future. Optical routers and optical computing will inevitably use the same principles for extracting part of the optical signal for monitoring and for similar uses.

Current available solutions for power monitoring involve using discrete splitters introduced in a main optical path (optical fiber), to divert part of the passing light to a monitor channel where the light is dispersed to its different wavelengths and monitored.

Alternatively part of the signal on each channel can be tapped after the signal passes a dispersion element, such as an arrayed waveguide grating (AWG) already present in the network. These elements usually are fabricated within a PLC chip, so that the light extraction is done within the chip, and the extracted light needs to be coupled out of the chip and into a light detector. The most common way of doing this coupling is by routing a waveguide to the edge of the chip, where the waveguide is coupled to an optical fiber. The other end of the fiber is connected to a photodetector.

These prior art monitoring methods all require the fabrication of additional elements within the monitored optical circuit itself. This adds significantly to the cost of the PLC chip. In addition, it is inherent to these methods that light that otherwise would be used for the optical circuit's primary purpose is diverted for the purpose of monitoring optical power. There is thus a widely recognized need for, and it would be highly advantageous to have, a method of monitoring the optical power in a PLC without fabricating additional elements within the PLC itself and without explicitly diverting light from the circuit.

### SUMMARY OF THE INVENTION

According to the present invention there is provided an optical circuit including: (a) a waveguide; and (b) an optical sensor, laterally displaced from the waveguide and sufficiently close to the waveguide to detect light emerging laterally from the waveguide.

According to the present invention there is provided a method of monitoring optical power in a waveguide embedded in an optical layer of an optical circuit, including the steps of: (a) mounting an optical sensor laterally apart from the waveguide and sufficiently close to the waveguide to detect light emerging laterally from the waveguide; and (b) receiving signals, from the optical sensor, that are representative of the optical power.

According to the present invention there is provided a method of monitoring optical power in a plurality of waveguides embedded in an optical layer of an optical circuit, including the steps of: (a) for each waveguide, mounting a respective optical sensor laterally apart from the each waveguide and sufficiently close to the each waveguide to detect light emerging laterally from the each waveguide; and (b) for each waveguide, receiving respective signals, from the respective optical sensor, that are representative of the optical power in the each waveguide.

The present invention exploits the fact that PLC waveguides are inherently lossy.

In a PLC, an optical circuit is created on the surface of a planar wafer using thin film deposition techniques similar to those used in the field of microelectronics.

The light propagates in waveguides that have cross sections of a few microns and that are located close to the upper surface of the wafer, typically within 20 microns of the upper surface of the wafer. Any such waveguide has an inherent loss, typically at least 0.01 dB/cm, implying that a small fraction of the light that propagates within the waveguide is scattered per unit length along the waveguide and emerges laterally from the waveguide.

The basic idea of the present invention is to mount an optical sensor on the upper surface of the wafer to intercept some of the light that emerges laterally from the waveguide. By being mounted on the upper surface of the wafer, the optical sensor is laterally displaced from the waveguide, meaning that the optical sensor is off to the side of the waveguide, and receives only light that emerges laterally from the waveguide, and not light that emerges from the end of the waveguide after propagating via the waveguide. Nevertheless, the optical sensor is close enough to the waveguide to detect the light that emerges laterally from the waveguide. The optical sensor responds to the light that it intercepts by generating signals that are representative of the optical power carried by the waveguide.

With the optical sensor mounted on the upper surface of the wafer, the optical sensor is vertically displaced from the waveguide, with the “vertical” direction being defined by the wafer geometry, and in particular by the optical layer in which the waveguide is embedded.

Preferably, the optical sensor is a photodiode.

Preferably, the optical sensor is laterally displaced from a structure of the waveguide, for example, from a bend in the waveguide, from a gap in the waveguide, from an intersection of the waveguide with another waveguide, or from a scatterer in the waveguide.

Preferably, the optical sensor is at most 50 microns away from the waveguide. Preferably, the optical sensor subtends an angle of at least about 124 degrees relative to the waveguide. Most preferably, the optical sensor subtends an angle of at least about 165 degrees relative to the waveguide.

Typically, the waveguide is fabricated by suitable doping of layer of a material that is optically transparent to the light that is carried by the waveguide. Examples of such materials include, for example, Silicon-based glasses such as SiO₂ and SiON, Silicon, Lithium Niobate and Indium Phosphide. Preferably, the optical sensor is mounted in a depression in the optical layer in which the waveguide is embedded.

Preferably, a bandpass filter, for example a grating or an interference filter, is placed between the waveguide and the optical sensor, to filter the light that emerges laterally from the waveguide.

Preferably, an interface is provided for connecting the optical sensor to an external electrical circuit. In one embodiment of the present invention, the interface includes an electrical conductor deposited on the optical layer in which the waveguide is embedded. In another embodiment of the present invention, the interface is adapted to connect the optical circuit to an external electrical circuit on a printed circuit board.

Preferably, the sensor is isolated from crosstalk, for example by means of one or more trenches, parallel to the waveguide, in the optical layer in which the waveguide is embedded, possibly with a metal deposited therein, or by means of an optically absorptive, most preferably metallic, barrier that at least partly surrounds the optical sensor.

Preferably, when several optical sensors are used to monitor optical power in several waveguides in the same optical circuit, the signals from the optical sensors are processed in a manner that compensates for crosstalk. Most preferably, this processing relies on crosstalk coefficients, representative of the crosstalk among the optical sensors, that are measured in a prior calibration step.

### BRIEF DESCRIPTION OF THE DRAWINGS

The invention is herein described, by way of example only, with reference to the accompanying drawings, wherein:

FIG. 1 is a schematic cross section of a PLC of the present invention;

FIG. 2 is a plan view of a PLC showing four kinds of waveguide structures;

FIG. 3 is a plan view of another PLC of the present invention.

### DESCRIPTION OF THE PREFERRED EMBODIMENTS

The present invention is of a method of monitoring optical power propagating via the waveguides of an optical circuit.

The principles and operation of optical power monitoring according to the present invention may be better understood with reference to the drawings and the accompanying description.

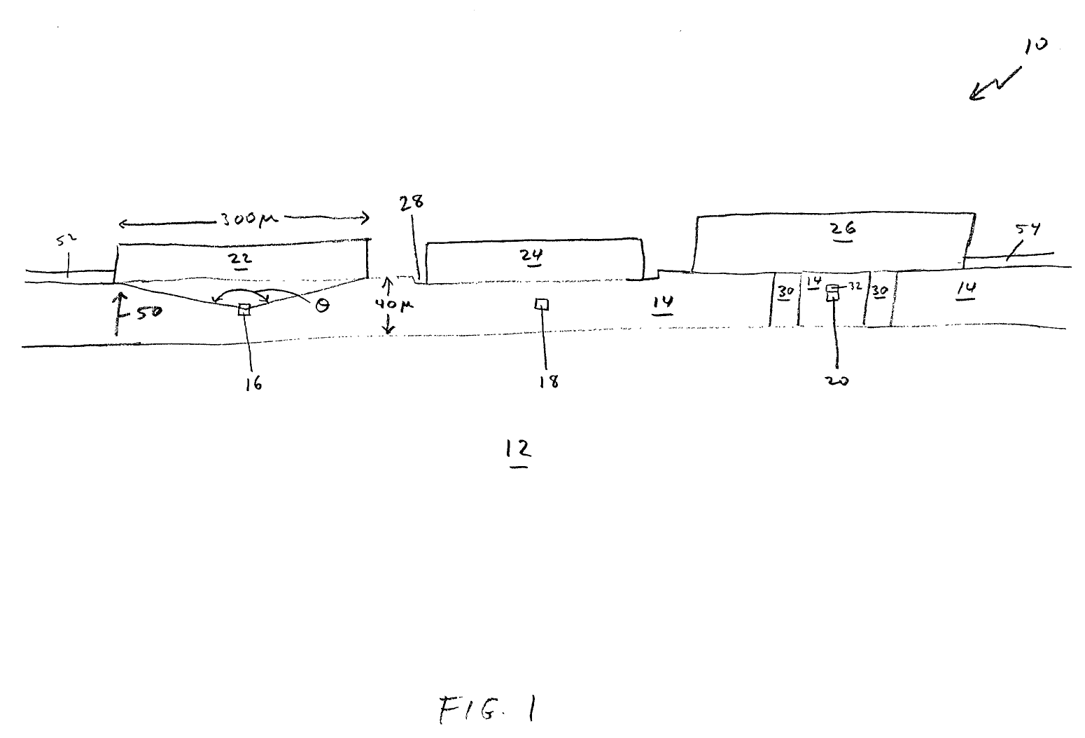

Referring now to the drawings, FIG. 1 is a schematic cross section of a PLC 10 configured according to the present invention with photodiodes 22, 24 and 26 for monitoring optical power propagating via respective waveguides 16, 18 and 20. PLC 10 consists of a substrate 12 above which is deposited an optical layer 14. Optical layer 14 is made of a material that is transparent to the light that propagates via waveguides 16, 18 and 20. Waveguides 16, 18 and 20 are formed in optical layer 14 by doping optical layer 14 locally to raise the local index of refraction. Typical materials that are used for substrate 12 and optical layer 14 include Silicon-based glasses such as SiO₂ and SiON, Silicon, Lithium Niobate and Indium Phosphide. Note that the cross section illustrated in FIG. 1 is transverse to waveguides 16, 18 and 20. The geometry of optical layer 14 defines a vertical direction 50, so that photodiodes 22, 24 and 26 are vertically displaced from their respective waveguides 16, 18 and 20.

Optical layer 14 typically is 40 microns thick, or thinner, and photodiodes 22, 24 and 26 typically are 300 microns wide, as shown. With waveguide 16 running through the middle of optical layer 14, so that the center of waveguide 16 is 20 microns below photodiode 22, this means that photodiode 22 subtends an angle θ of 165 degrees relative to waveguide 16, in order to intercept a substantial fraction of the light emerging locally from waveguide 16. Alternatively, photodiode 22, 24 or 26 could be only 75 microns wide, and so subtend an angle of only 124 degrees relative to waveguide 16, 18 or 20.

Photodiodes 22, 24 and 26 are representative of optical sensors generally. The scope of the present invention includes the use of any suitable optical sensor. In general, the separation between the optical sensor and the waveguide that it monitors preferably is at most about 50 microns, to ensure that the optical sensor intercepts a sufficient portion of the light that emerges laterally from the waveguide. The optical sensor is mounted directly on the upper surface of optical layer 14 without any special preparation of the upper surface of optical layer 14, as illustrated in FIG. 1 for photodiode 22. Alternatively, the optical sensor is mounted in a shallow depression in optical layer 14. Photodiode 24 is illustrated in FIG. 1 as mounted in a shallow depression 28 in optical layer 14.

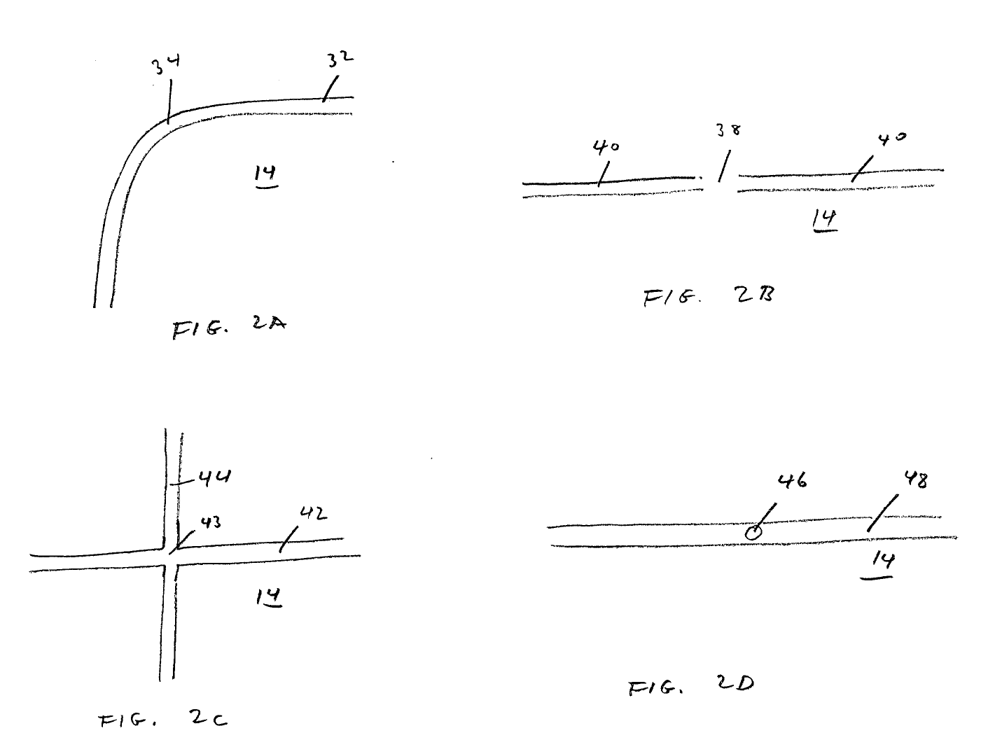

Preferably, the optical sensor is mounted in close proximity to a structure in the monitored waveguide at which lateral leakage of the light propagating via the waveguide is enhanced. FIG. 2 shows plan views of four such structures in waveguides in optical layer 14. FIG. 2A shows a bend 34 in a waveguide 32. FIG. 2B shows a gap 38 in a waveguide 40. FIG. 2C shows two waveguides 42 and 44 crossing at an intersection 43. FIG. 2D shows a scatterer 46 in a waveguide 48. Some of these structures, such as bend 34 and intersection 43, typically are present in PLC 10 anyway. Other structures, such as gap 38 and scatterer 46, are introduced deliberately to locally enhance the leakage of light from the monitored waveguide.

Returning to FIG. 1, a bandpass filter 32 is shown between waveguide 20 and photodiode 26. The purpose of bandpass filter 32, in a DWDM context, is to select only one of the wavelengths, that propagate in waveguide 20, for monitoring by photodiode 26. Bandpass filter 32 is realized by directing two crossed coherent ultraviolet beams on the portion of optical layer 14 that is to be modified. The resulting periodic interference pattern produces a corresponding change in the local index of refraction of optical layer 14. Bandpass filter 32 is illustrated as being adjacent to waveguide 20; but bandpass filter 32 could be formed anywhere between waveguide 20 and the upper surface of optical layer 14. Alternatively, bandpass filter 32 is realized as an interference filter by forming a stack of thin films in optical layer 14 above the portion of waveguide 20 that is to be monitored. Alternatively, bandpass filter 32 is realized as an external device between optical layer 14 and photodiode 26.

Also shown in FIG. 1 are two electrically conductive leads 52 and 54 for connecting photodiodes 22 and 26, respectively, to an external electrical circuit. Leads 52 and 54 are part of a metal layer that is deposited on optical layer 14, for example to drive optical gates that are part of the optical circuit. Alternatively, photodiodes 22, 24 and 26 are interfaced to an external electrical circuit in an external printed circuit board via bumps or wire bonds that directly contact the outward-facing surfaces of photodiodes 22, 24 and 26.

Also shown in FIG. 1 is a pair of trenches 30 in optical layer 14 that flank waveguide 20. The purpose of trenches 30 is to minimize crosstalk by scattering away light that emerges laterally from waveguides, such as waveguide 18, that are not to be monitored by photodiode 26, and that propagates towards waveguide 20 and photodiode 26 in optical layer 14. To this end, trenches 30 are deep trenches that traverse the full thickness of optical layer 14. Optionally, a metal (not shown) is deposited in trenches 30 to enhance the isolation of waveguide 20 from neighboring waveguides.

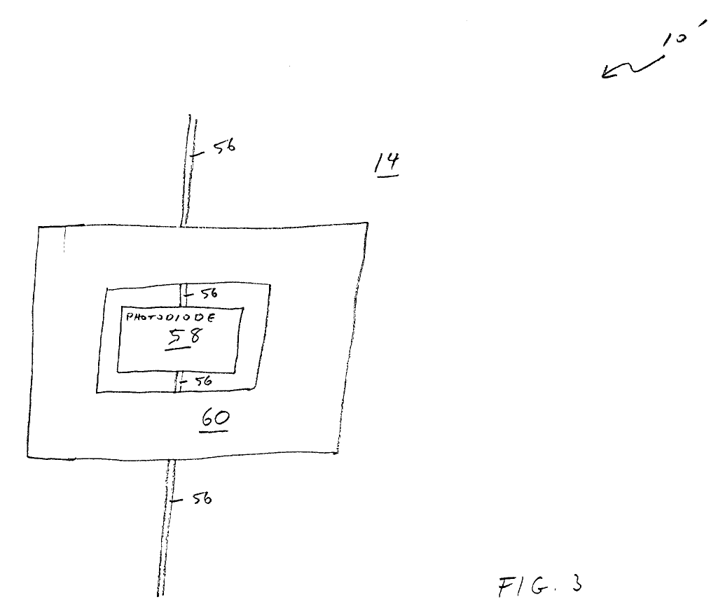

FIG. 3 is a partial plan view of another PLC 10′, showing another mechanism for isolating a photodiode 58, that is used to monitor a waveguide 56, from crosstalk. The metal layer that is deposited above optical layer 14 includes a ring 60 that surrounds photodiode 58. Metal ring 60 absorbs light that emerges laterally from adjacent waveguides and propagates towards waveguide 58.

Crosstalk is reduced further by appropriate processing of the signals from the photodiodes. To this end, it is necessary to calibrate PLC 10 by measuring the crosstalk between every waveguide and every photodiode. Assume a PLC 10 with M waveguides indexed by an index mε[1,M] and J photodiodes indexed by an index jε[1,f]. The “crosstalk coefficient” Aₘⱼ between waveguide m and photodiode j is defined as the signal obtained from photodiode j when waveguide m carries unit optical power and none of the other waveguides carry any optical power. It is assumed that the photodiodes are linear, so that the response of photodiode j to the optical power Pₘ carried by waveguide m is Sⱼ=AₘⱼPₘⱼ. Calibrating PLC 10 consists of sending known optical power successively through each of the M waveguides and measuring the resulting signals from the J photodiodes. Then, when PLC 10 is used operationally, with each waveguide m carrying optical power Pₘ, the signal Sⱼ from photodiode j is:

$${S}_{j} = {\sum }_{m = 1}^{M} {A}_{mj} {P}_{m}$$

If J>M, this is a set of overdetermined equations, for the powers Pₘ, that can be solved by standard methods. For example, if waveguide n is to be monitored by photodiode k, then to a first approximation (i.e., ignoring crosstalk), Pₙ=Sₖ/Aₙₖ. These approximate powers are the first estimates

$${P}_{m}^{( 1 )}$$

in an iterative scheme that converges to the desired solution. In the q-th iteration,

$${P}_{n}^{( q )} = \frac{1}{{A}_{nk}} [ {S}_{k} - {\sum }_{m \neq n}^{} {A}_{mk} {P}_{m}^{( q - 1 )} ]$$

While the invention has been described with respect to a limited number of embodiments, it will be appreciated that many variations, modifications and other applications of the invention may be made.

What is claimed is:

1. An optical circuit comprising:
(a) a waveguide; and
(b) an optical sensor, laterally displaced from said waveguide and sufficiently close to said waveguide to detect light emerging laterally from said waveguide.

2. The optical circuit of claim 1, further comprising:
(c) an optical layer wherein said waveguide is embedded; and wherein said optical sensor is vertically displaced, relative to said optical layer, from said waveguide.

3. The optical circuit of claim 2, wherein said optical layer includes a material selected from the group consisting of Silicon-based glasses, Silicon, Lithium Niobate and Indium Phosphide.

4. The optical circuit of claim 1, wherein said optical sensor is a photodiode.

5. The optical circuit of claim 1, wherein said optical sensor is laterally displaced from a structure of said waveguide.

6. The optical circuit of claim 5, wherein said structure is selected from the group consisting of a bend in said waveguide a gap, in said waveguide, an intersection with another waveguide and a scatterer in said waveguide.

7. The optical circuit of claim 1, wherein said optical sensor is at most about 50 microns from said waveguide.

8. The optical circuit of claim 1, wherein said optical sensor subtends an angle of at least about 124 degrees relative to said waveguide.

9. The optical circuit of claim 8, wherein said optical sensor subtends an angle of at least about 165 degrees relative to said waveguide.

10. The optical circuit of claim 1, further comprising:
(c) an optical layer wherein said waveguide is embedded; and wherein said optical sensor is in a depression in said optical layer.

11. The optical circuit of claim 1, wherein said optical layer includes a material selected from the group consisting of Silicon-based glasses, Silicon, Lithium Niobate and Indium Phosphide.

12. The optical circuit of claim 1, further comprising:
(c) a bandpass filter between said waveguide and said optical sensor.

13. The optical circuit of claim 12, wherein said bandpass filter includes a grating.

14. The optical circuit of claim 12, wherein said bandpass filter is an interference filter.

15. The optical circuit of claim 1, further comprising:
(c) an interface for connecting said optical sensor to an external electrical circuit.

16. The optical circuit of claim 15, further comprising:
(d) an optical layer wherein said waveguide is embedded;
and wherein said interface includes an electrical conductor deposited on said optical layer.

17. The optical circuit of claim 16, wherein said optical layer includes a material selected from the group consisting of Silicon-based glasses, Silicon, Lithium Niobate and Indium Phosphide.

18. The optical circuit of claim 15, wherein said interface is adapted to connect said optical sensor to said external electrical circuit on a printed circuit board.

19. The optical circuit of claim 1, further comprising:
(c) a mechanism for isolating said optical sensor from crosstalk.

20. The optical circuit of claim 19, further comprising:
(d) an optical layer wherein said waveguide is embedded;
and wherein said mechanism includes at least one trench, in said optical layer, parallel to said waveguide.

21. The optical circuit of claim 20, wherein said optical layer includes a material selected from the group consisting of Silicon-based glasses, Silicon, Lithium Niobate and Indium Phosphide.

22. The optical circuit of claim 20, wherein said mechanism further includes a metal deposited in at least one of said at least one trench.

23. The optical circuit of claim 19, wherein said mechanism includes an optically absorptive barrier at least partly surrounding said optical sensor.

24. The optical circuit of claim 23, wherein said optically absorptive barrier includes a metal.

25. A method of monitoring optical power in a waveguide embedded in an optical layer of an optical circuit, comprising the steps of:
(a) mounting an optical sensor laterally apart from the waveguide and sufficiently close to the waveguide to detect light emerging laterally from the waveguide; and
(b) receiving signals, from said optical sensor, that are representative of the optical power.

26. The method of claim 25, wherein said optical sensor is mounted vertically apart from the waveguide, relative to an optical layer wherein said waveguide is embedded.

27. The method of claim 25, wherein said optical sensor is a photodiode.

28. The method of claim 25, wherein said optical sensor is mounted laterally apart from a structure of said waveguide.

29. The method of claim 25, wherein said optical sensor is mounted at most about 50 microns from the waveguide.

30. The method of claim 25, wherein said optical sensor is mounted so as to subtend an angle of at least about 165 degrees relative to said waveguide.

31. The method of claim 25, wherein said optical sensor is mounted in a depression in the optical layer.

32. The method of claim 25, further comprising the step of:
(c) filtering said light that emerges laterally from the waveguide.

33. The method of claim 32, wherein said filtering is effected using a bandpass filter between the waveguide and said optical sensor.

34. The method of claim 25 further comprising the step of:
(c) isolating said optical sensor from crosstalk.

35. The method of claim 34, wherein said isolating is effected by steps including forming at least one trench in the optical layer parallel to the waveguide.

36. The method of claim 34, wherein said isolating is effected by steps including at least partly surrounding said optical sensor with an optically absorptive barrier.

37. A method of monitoring optical power in a plurality of waveguides embedded in an optical layer of an optical circuit, comprising the steps of:
(a) for each waveguide, mounting a respective optical sensor laterally apart from said each waveguide and sufficiently close to said each waveguide to detect light emerging laterally from said each waveguide; and
(b) for each waveguide, receiving respective signals, from said respective optical sensor, that are representative of the optical power in said each waveguide.

38. The method of claim 37, wherein, for each waveguide, said respective optical sensor is mounted vertically apart from said each waveguide, relative to an optical layer wherein said respective waveguide is embedded.

39. The method of claim 37, further comprising the step of:
(c) processing said signals in a manner that compensates for crosstalk.

40. The method of claim 39, further comprising the step of:
(d) for each said optical sensor, for each waveguide other than said respective waveguide, measuring a respective crosstalk coefficient; said crosstalk coefficients then being used in said processing.
